(19) United States
(12) Patent Application Publication
(10) Pub. No.: US 2011/0198452 A1
(43) Pub. Date: Aug. 18, 2011

(54) Twist lock conduit support clip

(76) Inventor: Scott Michael Barboza, Dighton, MA (US)

(21) Appl. No.: 12/658,704

(22) Filed: Feb. 16, 2010

(51) Int. Cl. F16L 3/08

(52) U.S. Cl. 248/74.1

(57) ABSTRACT

An improved method, and apparatus for securing a refrigeration lineset, or other conduit into an encapsulating raceway

### BACKGROUND-FIELD OF INVENTION

This device and method relates to conduit concealment and protection systems, otherwise known as raceway or ducting. More specifically it relates to an attachment means used to secure conduit and/or wiring within the ducting.

### BACKGROUND-DESCRIPTION OF PRIOR ART

Over the years, a variety of different air conditioning systems have been developed for cooling interior spaces. One common type of system, referred to as a “split system” uses an exterior condensing unit usually located outdoors at ground level, and an interior air handling unit, commonly mounted in an overhead attic space.

Because the two components of a split-system air conditioner are remotely located from one another, they are connected by a refrigerant “lineset” comprising a supply line, a return line, and a voltage control wire. The supply and return lines are typically copper tubing and one or both may include a wrapping of insulation (e.g., foam tubing).

Commonly, when such a system is installed in an existing dwelling or building, the lineset must be routed along the exterior, which can be unattractive, and can expose the lineset to damage and wear from sunlight or weather. Raceway, or ducting systems are sometimes used to encapsulate and protect the lineset. One type of ducting uses a two piece design. A U-shaped length of base channel is secured to the building. After the lineset is placed into this first base channel, a second or cover channel is secured, over the assembly to form a finished duct. Typically, some type of snap lock arrangement is used to secure the two halves of the duct together.

Although somewhat common, trying to install the second halve of the ducting without first securing the lineset to the first half with fasteners is tedious and difficult. A tie wrap mounting base is sometimes used for this purpose. It is usually secured with screws through the first channel into the building at various points along the channel's length. A tie wrap can then be routed through a slot in the mounting base, then around the lineset and tightened, securing it in place.

One problem with this method is that when securing the tie wrap mounting bases, one must carefully choose the proper placement and spacing, since they are very difficult to relocate after the lineset is in place. Also, since these ducting systems are commonly made from plastic, they will expand and contract with varying outdoor ambient temperatures. Oblong shaped holes must be punched in the first channel where screws pass through the duct to allow for this movement. If this is done before installation, it limits placement of the clips to the location of the oblong holes. The lineset is typically supplied to the installer in rolled form. It is unrolled on the jobsite before installation. Since it is very difficult to unroll it into a perfectly straight form, when placed into the first duct channel the lineset can have curved, or raised sections than make it difficult or impossible to install the second channel. These areas need to be pulled into the channel by strategic location of fasteners and tie wraps. If, after installation, the lineset needs additional fastening, or relocation of existing fasteners to achieve this, it requires disassembly of the system to punch new oblong holes.

Another type of tie wrap mounting base simply engages, and slides into or over a track formed along the length of the base channel. While this method is an improvement on the screw mounted tie wrap mounting base, it makes it very difficult to add a mounting point to the installation if needed between existing points. This is because this type of mounting base must be inserted into the end of the base channel and slid into position, interfering with existing mounting bases, and the lineset itself. Although this arrangement allows for lateral movement from thermal expansion and contraction, the fit of this mounting base must be tight enough within the track to secure the tubing in place against gravity. Consequently, this may make it very difficult to slide into position along the track.

### OBJECTS AND ADVANTAGES

Accordingly, the objects and advantages of the current invention are
a) to provide a simple and reliable means for securing tubing or wiring to a raceway
b) to provide a flexible mounting means that allows attachment at infinite lateral points
c) to provide for the ability to add additional fastening points if needed between existing ones during installation
d) to provide an easy to install fastening means that requires no tools
e) to provide a fastening system that allows for expansion and contraction without distorting or stressing the system.

### SUMMARY OF THE INVENTION

The present invention overcomes many of the disadvantages of prior art refrigeration lineset installation by providing an easier to install mounting means, which when installed on a lineset, will allow for lateral movement, both for relocation, and to allow for expansion and contraction

### BRIEF DESCRIPTION OF THE DRAWINGS

FIG. 1a is a perspective view illustrating the present invention with it's various parts

FIG. 1b illustrates the present invention partially installed into the duct channel

FIG. 1C depicts the present invention in a fully installed state

### REFERENCE NUMERALS IN DRAWINGS

10 conduit support clip main body

12 boss

14 tie wrap slot

16 radial leading edge

18 engagement leg

20 rail

22 duct base channel

24 duct cover

26 lineset

28 tie wrap

### DETAILED DESCRIPTION OF THE INVENTION

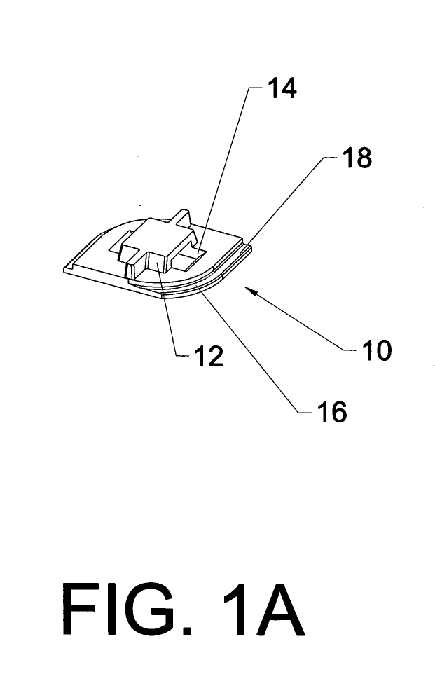

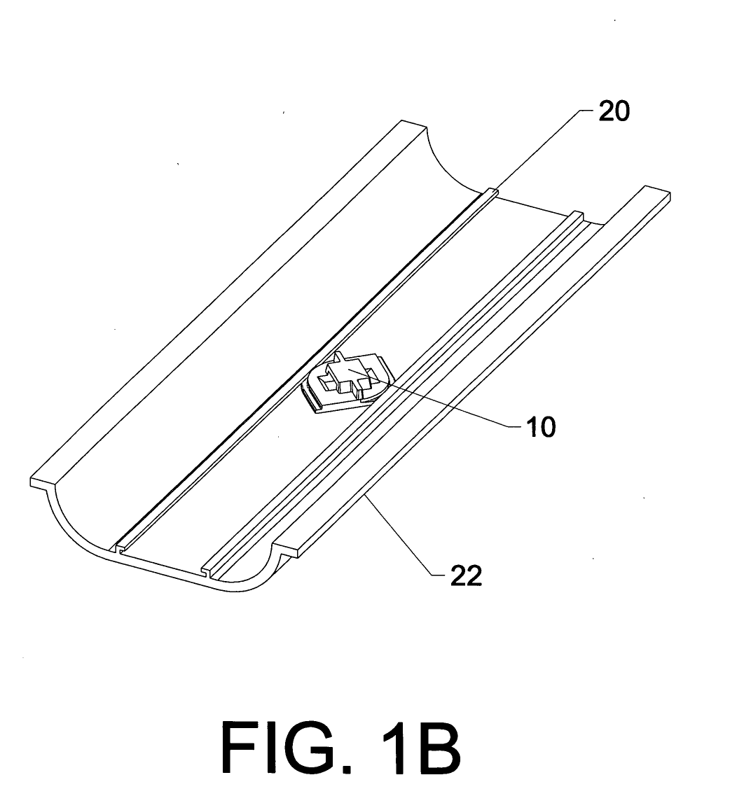

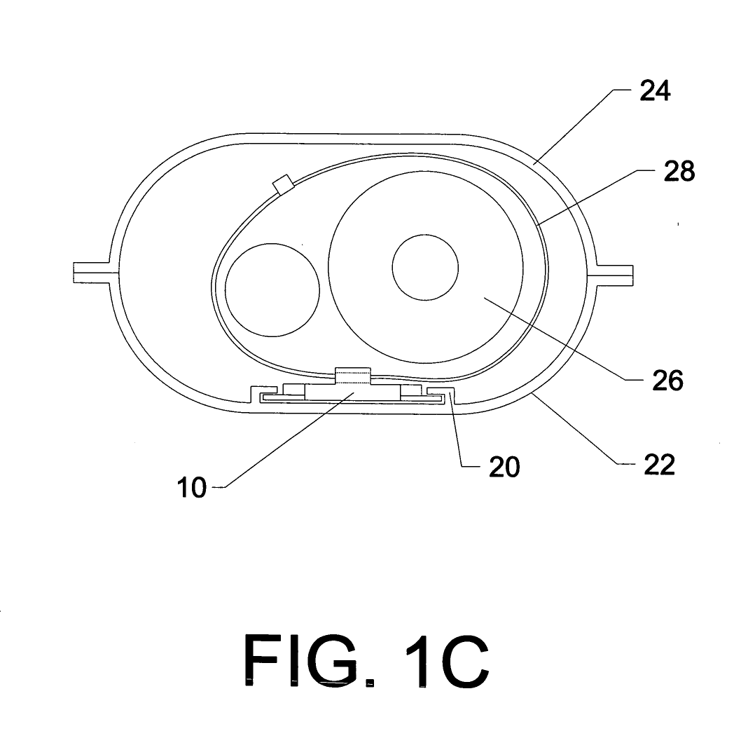

FIG. 1a shows a perspective view of an embodiment of the conduit support clip 10. The clip 10 is generally square in shape having two opposite corners rounded, forming a radial leading edge 16 along each. Along a portion of edge 16 is an outwardly facing engagement leg 18. A cube shaped boss 12 is located centrally and protrudes from the main body 10. Located within boss 12 is tie wrap slot 14.

FIG. 1b depicts clip 10 partially installed into the duct base channel 22. The duct base channel 22 contains two parallel L-shaped, inwardly facing rails 20. The distance between the rails 20 is sufficient to accommodate the clip 10.

FIG. 1c shows the present invention in its fully installed state. The clip 10 is nested between the rails 20. A standard, suitably sized tie wrap 28 passes through the tie wrap slot 14 and around the lineset 26 to secure it in place.

### Operation

The present invention is installed in the following manner. The duct base channel 22 is first secured to the building. A clip 10 is inserted into the duct base channel and positioned between the two rails 20 with the rounded corners adjacent to the rails 20. This position allows insertion of the clip 10 between the rails 20. The clip 10 is then rotated ninety degrees clockwise, inserting the engagement legs 18 into the space created between the rails 20 and the base channel 22. All part dimensions allow easy positioning of the clip 10, but are designed to create a degree of friction, when rotated into position. This is repeated at sufficient intervals along the length of the channel 22. After the lineset 26 is positioned within the base channel 22, a tie wrap 28 is inserted into and through the tie wrap slot 14 and around the lineset 26, and tightened. This operation is repeated at each clip 10. If during installation, additional fasteners are needed, a clip 10 may be slipped behind the lineset 26, and installed as described above.

### Summary, Ramifications, and Scope

This invention provides for an improved method of mounting a conduit, or lineset within a raceway type ducting system.

Although the description above contains much specificity, these should not be construed as limiting the scope of the invention but as merely providing illustrations of some of the preferred embodiments of this invention.

What is claimed:

1. A securing means for refrigerant lines for use within an enclosure for said refrigerant lines comprising:
a. A track located at the rear of said enclosure and running along the length of said enclosure with a cross section formed to create two captive portions to accept a securing means and,
b. A securing means formed with a short side with a length less than the distance between said two captive portions intended to allow placement directly between said two captive portions, and an adjacent long side, said long side having a portion which has a thickness intended to fit behind said two captive portions of said track upon rotating said securing means while located partially behind said two captive portions, and
c. An opening in said securing means to allow the passage of a flexible fastening means to pass around the perimeter of said refrigerant lines.

2. The securing means in claim 1 wherein said adjacent long side contains a stopping means to prevent the rotation of said securing means beyond an ideal angle.

3. The securing means in claim 1 wherein said opening is behind a protrusion intended to reinforce said opening to prevent damage from said fastening means if said fastening means should be over tightened.

4. The securing means in claim 1 wherein a grasping means is located on the front of said securing means adjacent to said opening to assist an installer of said securing means to position and rotate said securing means.
